(19) United States
(12) Patent Application Publication
(10) Pub. No.: US 2025/0329898 A1
(43) Pub. Date: Oct. 23, 2025

(54) CONDUCTIVE MODULE

(71) Applicant: YAZAKI CORPORATION, Tokyo (JP)

(72) Inventors: Tatsuya Oga, Makinohara-shi (JP); Katsunori Sato, Makinohara-shi (JP); Mariko Nakagawa, Makinohara-shi (JP)

(21) Appl. No.: 19/183,752

(22) Filed: Apr. 18, 2025

(30) Foreign Application Priority Data
Apr. 23, 2024 (JP) 2024-069419

(51) Int. Cl. H01M 50/583; H01M 10/48; H01M 50/507

(52) U.S. Cl. CPC H01M 50/583; H01M 10/48; H01M 50/507

(57) ABSTRACT

Provided is a conductive module including: a busbar connected to an electrode terminal of a battery cell constituting a battery module; a wiring component configured to electrically connect the busbar to a battery monitoring unit that monitors a battery state; a conductive member connected to the busbar; and a circuit protection component configured either as a chip fuse having a fusible portion to be fused when an overcurrent flows or a fuse with a wiring pattern in which a wiring pattern having the fusible portion is provided on a printed circuit board. The circuit protection component is configured to connect a first electrical connection portion on one end side as viewed from the fusible portion, to a first fuse connecting portion of the wiring component, and connect a second electrical connection portion on the other end side as viewed from the fusible portion, to a second fuse connecting portion.

### CROSS-REFERENCE TO RELATED APPLICATION(S)

The present application claims priority to and incorporates by reference the entire contents of Japanese Patent Application No. 2024-069419 filed in Japan on Apr. 23, 2024.

### BACKGROUND OF THE INVENTION

### 1. Field of the Invention

The present invention relates to a conductive module.

### 2. Description of the Related Art

A conductive module includes a battery module in which a plurality of battery cells is lined up, and electrically connects, in the battery module, the plurality of battery cells to each other using a plurality of busbars. In addition, the conductive module electrically connects each busbar to a battery monitoring unit, a unit provided to monitor the battery state of the battery cell, using a wiring component such as an electrical cable. This type of conductive module is disclosed in the following JP 2020-119 651 A, for example.

Meanwhile, there is a case, in the conductive module, where a circuit protection component such as a fuse is interposed between the busbar and the wiring component, and this addition of the circuit protection component causes enlargement of the conductive module. Therefore, the conductive module is required to be improved in mountability onto the battery module.

### SUMMARY OF THE INVENTION

In view of this, an object of the present invention is to provide a conductive module having excellent mountability.

In order to achieve the above mentioned object, a conductive module according to one aspect of the present invention includes a busbar physically and electrically connected to an electrode terminal of a battery cell constituting a battery module; a wiring component configured to electrically connect the busbar to a battery monitoring unit that monitors a battery state of the battery cell; a conductive member physically and electrically connected to the busbar; and a circuit protection component configured either as a chip fuse having a fusible portion to be fused when an overcurrent flows or a fuse with a wiring pattern in which a wiring pattern having the fusible portion is provided on a printed circuit board, the circuit protection component being configured to physically and electrically connect a first electrical connection portion on one end side as viewed from the fusible portion, to a first fuse connecting portion of the wiring component, and physically and electrically connect a second electrical connection portion on the other end side as viewed from the fusible portion, to a second fuse connecting portion of the conductive member.

In order to achieve the above mentioned object, a conductive module according to another aspect of the present invention includes a busbar physically and electrically connected to an electrode terminal of a battery cell constituting a battery module; a wiring component configured to electrically connect the busbar to a battery monitoring unit that monitors a battery state of the battery cell; and a circuit protection component configured either as a chip fuse having a fusible portion to be fused when an overcurrent flows or a fuse with a wiring pattern in which a wiring pattern having the fusible portion is provided on a printed circuit board, the circuit protection component being configured to physically and electrically connect a first electrical connection portion on one end side as viewed from the fusible portion, to a first fuse connecting portion of the wiring component, and physically and electrically connect a second electrical connection portion on the other end side as viewed from the fusible portion, to a second fuse connecting portion of the busbar.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a conductive module according to an embodiment;

FIG. 2 is an exploded perspective view illustrating the conductive module of the embodiment;

FIG. 3 is a schematic view illustrating a battery module together with a busbar;

FIG. 4 is a plan view illustrating a variation of a wiring component of the embodiment;

FIG. 5 is a plan view illustrating a variation of a busbar-side conductive member of the embodiment;

FIG. 6 is a plan view illustrating a variation of the wiring component of the embodiment;

FIG. 7 is a perspective view illustrating a variation of a circuit protection component of the embodiment;

FIG. 8 is a perspective view illustrating a variation of the circuit protection component of the embodiment;

FIG. 9 is a plan view illustrating a wiring component used in a conductive module of a first modification;

FIG. 10 is a perspective view illustrating a conductive module of a second modification;

FIG. 11 is a perspective view illustrating the conductive module of the second modification;

FIG. 12 is a perspective view illustrating a conductive module of a third modification;

FIG. 13 is a perspective view illustrating the conductive module of the third modification;

FIG. 14 is a perspective view illustrating a conductive module of a fourth modification;

FIG. 15 is a perspective view illustrating the conductive module of the fourth modification;

FIG. 16 is a perspective view illustrating a conductive module of a fifth modification; and

FIG. 17 is a perspective view illustrating the conductive module of the fifth modification.

### DETAILED DESCRIPTION OF THE PREFERRED EMBODIMENTS

Embodiments of a conductive module according to the present invention will be described below in detail with reference to the drawings. Note that the present invention is not limited by the embodiment.

### Embodiment

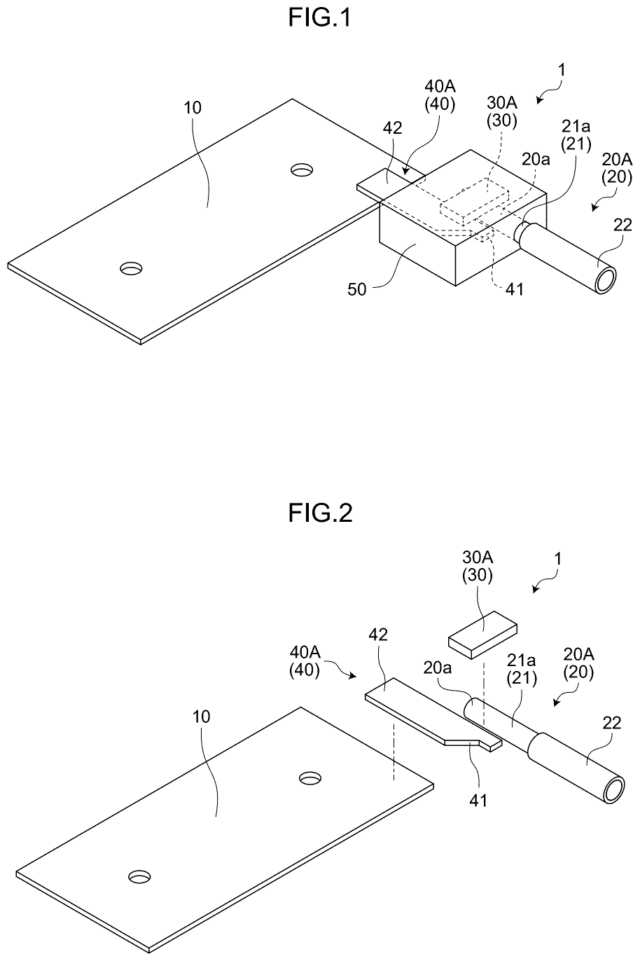

One embodiment of the conductive module according to the present invention will be described with reference to FIGS. 1 to 8.

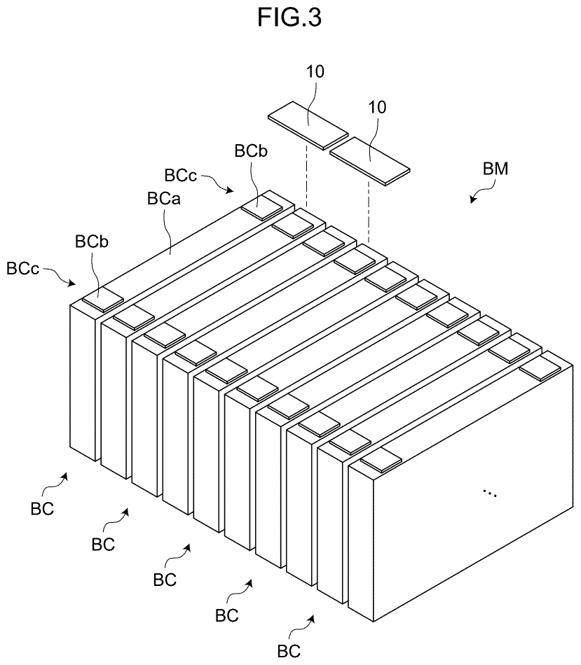

Reference sign 1 in FIGS. 1 and 2 denotes a conductive module of the present embodiment. The conductive module 1 is assembled to a battery module BM (FIG. 3) in which a plurality of battery cells BC is lined up (for example, in a single row) so as to electrically connect the plurality of battery cells BC in the battery module BM to each other. The conductive module 1 electrically connects the battery module BM to a battery monitoring unit (not illustrated) to allow the battery monitoring unit to monitor the battery state of the battery cell BC. The conductive module 1, together with the battery module BM, constitute a battery pack. The battery pack is mounted on, for example, a vehicle (such as a Battery Electric Vehicle (BEV) and a Hybrid Electric Vehicle (HEV)) including a rotating machine as a drive source, and is used for purposes such as power supply to the rotating machine.

The battery cell BC includes a cell body BCa and electrode terminals BCb, provided as positive and negative terminals (FIG. 3). In the battery cell BC depicted here, the cell body BCa is formed in a rectangular parallelepiped shape having six outer wall surfaces. In the plurality of battery cells BC constituting the battery module BM, the cell bodies BCa adjacent to each other in the line-up direction are disposed with one outer wall surface facing each other. The battery module BM includes: a one-side electrode terminal group BCc in which one-side electrode terminals BCb of each battery cell BC are disposed in a line-up direction; and an other-side electrode terminal group BCc in which other-side electrode terminals BCb of each battery cell BC are disposed in the line-up direction (FIG. 3).

In this example, each battery cell BC includes the electrode terminals BCb, including positive and negative electrodes, on one of the six outer wall surfaces of the cell body BCa (FIG. 3). Accordingly, the battery module BM has two electrode terminal groups BCc provided on one plane (FIG. 3).

In addition, the electrode terminal BCb depicted here is formed in a flat plate shape, and is to be physically and electrically connected with a busbar 10 to be described below by welding, for example (FIG. 3). However, the electrode terminal BCb may be formed in a pole shape having a male screw portion. In this case, a female screw member is screwed to the male screw portion of the electrode terminal BCb so as to fix, by screwing, the busbar 10 to the electrode terminal BCb.

The conductive module 1 includes the busbar 10 to be physically and electrically connected to the electrode terminal BCb of the battery cell BC constituting the battery module BM (FIGS. 1 to 3).

The busbar 10 is formed of a conductive material such as metal. The busbar 10 is a plate-like conductive component formed of metal, and is press-formed using a metal plate as a base material, for example. The busbar 10 depicted here is formed in a rectangular flat plate shape.

The conductive module 1 includes, as the busbars 10, for example: a busbar to be physically and electrically connected to the adjacent electrode terminals BCb of the pair of battery cells BC in the battery module BM; a busbar to be physically and electrically connected to the electrode terminal BCb to be a total negative electrode in the battery module BM; and a busbar to be physically and electrically connected to the electrode terminal BCb to be a total positive electrode in the battery module BM.

The conductive module 1 includes a wiring component 20 provided to electrically connect the busbar 10 to the battery monitoring unit (FIGS. 1 and 2). The conductive module 1 includes a circuit protection component 30 interposed between the busbar 10 and the wiring component 20 (FIGS. 1 and 2). The conductive module 1 of the present embodiment includes a conductive member (hereinafter, referred to as a “busbar-side conductive member”) 40 interposed between the busbar 10 and the circuit protection component 30 (FIGS. 1 and 2). In the conductive module 1, the wiring component 20, the circuit protection component 30, and the busbar-side conductive member 40 are provided for each busbar 10.

The wiring component 20 is an electrical cable (hereinafter, referred to as an “wiring electrical cable”) in which a core wire 21 is covered with an insulating covering 22 (FIGS. 1 and 2). At an end of the wiring component 20, the core wire 21 is exposed from the insulating covering 22. The core wire 21 depicted here is exposed in a state of protruding from the insulating covering 22 at the end of the wiring component 20. Hereinafter, the exposed portion of the core wire 21 is referred to as a core wire exposed portion 21a.

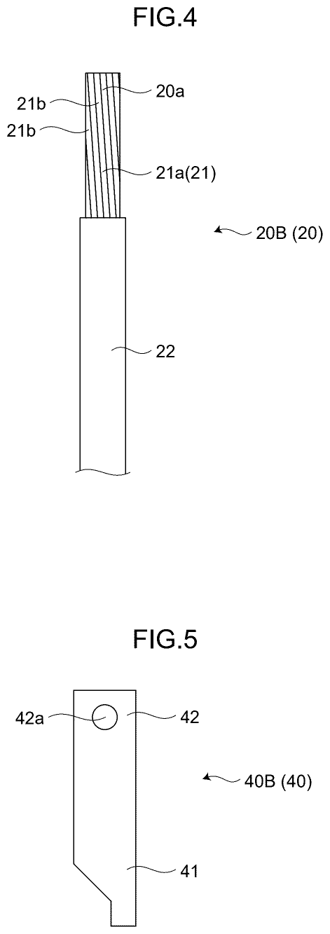

The wiring component 20 may be a wiring electrical cable (a wiring component 20A in FIGS. 1 and 2) that has a single wire of a round conductor as the core wire 21. The wiring component 20 may be a wiring electrical cable (a wiring component 20B in FIG. 4) in which a stranded wire obtained by twisting a plurality of strands 21b is used as the core wire 21. The wiring component 20 depicted here is formed in a cylindrical shape regardless of which of the above is used for the core wire 21.

The circuit protection component 30 is a fuse that interrupts energization when an overcurrent flows. The circuit protection component 30 used here is configured as a chip fuse (illustrated as a circuit protection component 30A in FIGS. 1 and 2), being a fuse having a fusible portion to be fused when an overcurrent flows. The circuit protection component 30 has its one end side electrically connected to the busbar 10 and the other end side electrically connected to the wiring component 20.

The circuit protection component 30 depicted here physically and electrically connects a first electrical connection portion on one end side as viewed from the fusible portion to a first fuse connecting portion 20a of the wiring component 20 (FIGS. 1 and 2). The first fuse connecting portion 20a is provided at the core wire exposed portion 21a of the wiring component 20. In the conductive module 1, the first fuse connecting portion 20a (core wire exposed portion 21a) of the wiring component 20 and the first electrical connection portion of the circuit protection component 30 are physically and electrically connected to each other by soldering or welding, for example. For example, the solder may be applied to the first fuse connecting portion 20a (core wire exposed portion 21a) in advance, or may be a thread solder to be fed during the connecting operation.

The circuit protection component 30 depicted here physically and electrically connects a second electrical connection portion on the other end side as viewed from the fusible portion to a second fuse connecting portion 41 of the busbar-side conductive member 40 (FIGS. 1 and 2).

The busbar-side conductive member 40 is formed of a conductive material such as metal, and is physically and electrically connected to the busbar 10 and the second electrical connection portion of the circuit protection component 30. For example, the busbar-side conductive member 40 is formed as a terminal fitting. The busbar-side conductive member 40 depicted here is formed as a terminal fitting having a flat plate shape and extending in one direction, and has its one end in the longitudinal direction formed as the second fuse connecting portion 41 while having the other end in the longitudinal direction formed as a busbar connecting portion 42 to be physically and electrically connected to the busbar 10 (FIGS. 1 and 2).

In the conductive module 1, the second fuse connecting portion 41 of the busbar-side conductive member 40 and the second electrical connection portion of the circuit protection component 30 are physically and electrically connected to each other by soldering or welding, for example. For example, the solder may be applied to the second fuse connecting portion 41 in advance, or may be a thread solder to be fed during the connecting operation.

The busbar-side conductive member 40 physically and electrically connects the busbar connecting portion 42 to the busbar 10 in a state where the second fuse connecting portion 41 protrudes from the busbar 10 in a direction orthogonal to the line-up direction of the plurality of battery cells BC. In the conductive module 1, the busbar connecting portion 42 and the busbar 10 are physically and electrically connected by a process such as welding, for example. In this manner, the busbar-side conductive member 40 may be a member to physically and electrically connect the busbar connecting portion 42 and the busbar 10 to each other by welding, for example (such as a busbar-side conductive member 40A in FIGS. 1 and 2). In addition, the busbar-side conductive member 40 may be a member to physically and electrically connect the busbar connecting portion 42 and the busbar 10 to each other by screwing fixation (such as a busbar-side conductive member 40B in FIG. 5). In the busbar-side conductive member 40B, the busbar connecting portion 42 has a through hole 42a through which a male threaded member (not illustrated) is to be inserted. In the busbar-side conductive member 40, the busbar connecting portion 42 may be formed as a female terminal portion or a male terminal portion, and the busbar connecting portion 42 may be fitted and connected, with a mating connection, to the male terminal portion or the female terminal portion of the busbar 10.

In the conductive module 1, the wiring component 20 (wiring electrical cable) and the busbar-side conductive member 40 are disposed such that the axial direction of the wiring component 20 (wiring electrical cable) and the longitudinal direction of the busbar-side conductive member 40 are parallel to each other and such that the first fuse connecting portion 20a (core wire exposed portion 21a) of the wiring component 20 (wiring electrical cable) and the second fuse connecting portion 41 of the busbar-side conductive member 40 face each other. Here, the wiring component 20 (wiring electrical cable) and the busbar-side conductive member 40 are disposed such that the line-up direction of the wiring component 20 (wiring electrical cable) and the busbar-side conductive member 40 (that is, a facing arrangement direction of the first fuse connecting portion 20a and the second fuse connecting portion 41) is parallel to the plane of the busbar 10.

For example, in the conductive module 1, the circuit protection component 30 is disposed on a jig with the first electrical connection portion and the second electrical connection portion facing upward, and then, the first fuse connecting portion 20a (core wire exposed portion 21a) of the wiring component 20 (wiring electrical cable) is placed on the first electrical connection portion. In this state, the first fuse connecting portion 20a (core wire exposed portion 21a) and the first electrical connection portion are physically and electrically connected to each other by soldering or welding, for example. In addition, in the conductive module 1, the circuit protection component 30 is placed on one plane of the second fuse connecting portion 41 of the busbar-side conductive member 40, and in this state, the second electrical connection portion of the circuit protection component 30 and the second fuse connecting portion 41 are physically and electrically connected to each other by soldering or welding, for example.

The conductive module 1 is equipped with an insulating member 50 that contains the circuit protection component 30, the first fuse connecting portion 20a, and the second fuse connecting portion 41 so as to maintain the connection state of these components (FIG. 1). The insulating member 50 is formed of an insulating material such as synthetic resin.

For example, the insulating member 50 is either: a molded body insert-molded by containing the circuit protection component 30, the first fuse connecting portion 20a, and the second fuse connecting portion 41; or a cured body obtained by curing a potting liquid containing the circuit protection component 30, the first fuse connecting portion 20a, and the second fuse connecting portion 41. The insulating member 50 may be a box body that includes a plurality of case members assembled to each other and houses the circuit protection component 30, the first fuse connecting portion 20a, and the second fuse connecting portion 41 in a housing chamber inside the plurality of case members assembled to each other. In the insulating member 50, by using mutual engagement of engagement portions such as claws provided in the individual case members, the assembly completion states of the individual case members are maintained.

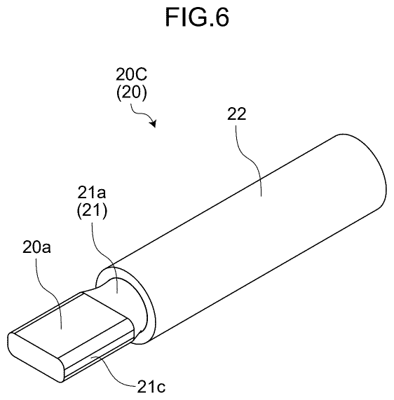

Here, the conductive module 1 of the present embodiment may use the wiring component 20 (illustrated as a wiring component 20C in FIG. 6) obtained by performing forming processing on the core wire exposed portion 21a. In the wiring component 20C (wiring electrical cable), the core wire 21 is to be a bundle of a plurality of strands. In the wiring component 20C, forming processing is performed on the core wire exposed portion 21a so as to provide the core wire exposed portion 21a with a terminal portion 21c at which a plurality of strands are welded together (FIG. 6). The terminal portion 21c is provided, at least at one location, with a plane on which the circuit protection component 30 is placed. For example, here, the terminal portion 21c is formed by resistance welding or ultrasonic welding while pressurizing the core wire exposed portion 21a. On the core wire exposed portion 21a, the planar portion of the terminal portion 21c is used as the first fuse connecting portion 20a.

In the conductive module 1, the first fuse connecting portion 20a (planar portion of the terminal portion 21c) of the wiring component 20C (wiring electrical cable) and one plane of the second fuse connecting portion 41 of the busbar-side conductive member 40 are disposed on an identical plane, so as to dispose the wiring component 20C (wiring electrical cable) and the busbar-side conductive member 40. Here, the wiring component 20C (wiring electrical cable) and the busbar-side conductive member 40 are disposed on the identical plane, which is located parallel to the plane of the busbar 10. In the conductive module 1, the circuit protection component 30 is placed on the first fuse connecting portion 20a (the planar portion of the terminal portion 21c) and on the one plane of the second fuse connecting portion 41, and in this state, the circuit protection component 30 can be physically and electrically connected to the first fuse connecting portion 20a and the second fuse connecting portion 41 by soldering or welding, for example. Consequently, in the conductive module 1, even when the circuit protection component 30 is a chip fuse, the circuit protection component 30, maintained in a stable state, can be placed on the first fuse connecting portion 20a and the second fuse connecting portion 41.

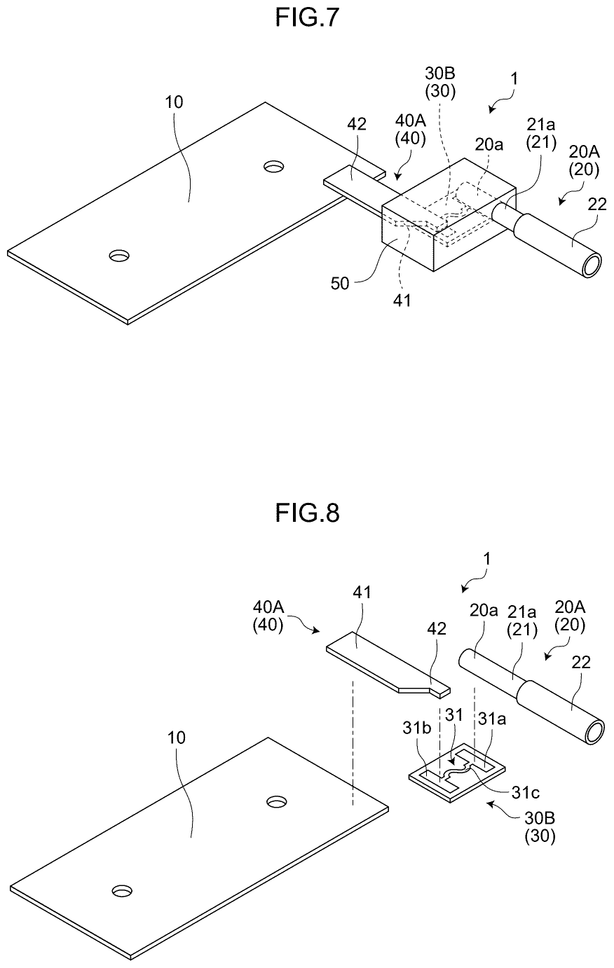

In addition, the circuit protection component 30 may be configured as a fuse with a wiring pattern, in which a wiring pattern 31 is provided on a printed circuit board (flexible printed circuit board or rigid board) (illustrated as a circuit protection component 30B in FIGS. 7 and 8). The wiring pattern 31 includes: a first electrical connection portion 31a to be physically and electrically connected to the first fuse connecting portion 20a of the wiring component 20 (wiring electrical cable); and a second electrical connection portion 31b to be physically and electrically connected to the second fuse connecting portion 41 of the busbar-side conductive member 40 (FIGS. 7 and 8). The wiring pattern 31 also includes a fusible portion 31c provided between the first electrical connection portion 31a and the second electrical connection portion 31b (FIGS. 7 and 8).

In the conductive module 1, for example, the first fuse connecting portion 20a (core wire exposed portion 21a) of the wiring component 20 (wiring electrical cable) and the second fuse connecting portion 41 of the busbar-side conductive member 40 are respectively placed on the first electrical connection portion 31a and the second electrical connection portion 31b of the circuit protection component 30B, and in this state, the circuit protection component 30B is physically and electrically connected to the first fuse connecting portion 20a and the second fuse connecting portion 41 by soldering or welding, for example.

In the conductive module 1 of the present embodiment, the busbar-side conductive member 40 may be an electrical cable (not illustrated). In this case, on the busbar-side conductive member 40, for example, the core wire exposed portion exposed from one end of the member is to be the second fuse connecting portion 41, while the core wire exposed portion exposed from the other end is to be the busbar connecting portion 42.

The conductive module 1 according to present embodiment described above includes the circuit protection component 30 such as a chip fuse or a fuse with a wiring pattern smaller in size than a mechanical fuse such as a blade fuse, and allows the circuit protection component 30 to be directly connected to the first fuse connecting portion 20a of the wiring component 20 and to the second fuse connecting portion 41 of the busbar-side conductive member 40. This makes the conductive module 1 according to the present embodiment a downsized module with excellent mountability. In the conductive module 1 of the present embodiment, the circuit protection component 30, the first fuse connecting portion 20a of the wiring component 20, and the second fuse connecting portion 41 of the busbar-side conductive member 40 are covered with the insulating member 50. This allows the conductive module 1 of the present embodiment to maintain the electrical connection stability of the components while achieving downsizing.

The conductive module 1 of the present embodiment, when using a chip fuse for the circuit protection component 30, can reduce the cost as compared with the case of using a mechanical fuse such as a blade fuse. In addition, by connecting the circuit protection component 30 to the wiring component 20 and the busbar-side conductive member 40 by soldering or welding, the conductive module 1 of the present embodiment can suppress the contact resistance at the connecting portion to be low as compared with the case of using a mechanical fuse such as a blade fuse.

In the conductive module 1 of the present embodiment, the wiring component 20, the circuit protection component 30, and the busbar-side conductive member 40 can be connected in advance, and the busbar-side conductive member 40 of the assembly can be physically and electrically connected to the busbar 10. This makes it possible to increase the productivity of the conductive module 1 of the present embodiment.

### First Modification

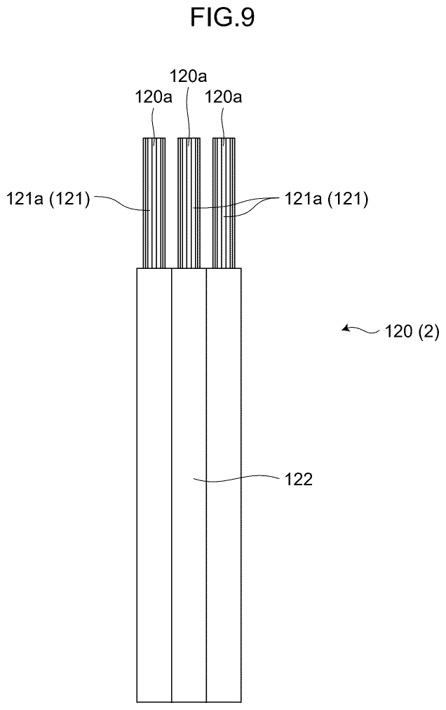

A conductive module 2 of the present modification is obtained by performing replacement in the conductive module 1 of the above-described embodiment, specifically, by replacing the wiring component 20 prepared for each busbar 10 with a wiring component 120 described below (FIG. 9). The present modification will omit illustration and description of members and portions similar to those of the conductive module 1 of the embodiment. In a same manner as the embodiment, the circuit protection component 30 of the present modification may be a chip fuse or a fuse with a wiring pattern. The busbar-side conductive member 40 of the present modification may be formed as a terminal fitting, or may be an electrical cable, in a same manner as the embodiment.

The wiring component 120 of the present modification is a flat cable in which a line-shaped conductor 121 of each busbar 10 is covered with an insulating covering 122 (FIG. 9). The line-shaped conductor 121 of the wiring component 120 depicted here is one similar to the core wire 21 having a cylindrical shape, such as the single wire or the stranded wire of the round conductor depicted in the embodiment. In the wiring component 120, ends of the respective line-shaped conductors 121 are exposed from the insulating covering 122. The line-shaped conductor 121 depicted here has its end exposed in a state of protruding from the insulating covering 122. Hereinafter, the end of the line-shaped conductor 121 is referred to as a conductor exposed portion 121a.

Similarly to the wiring component 20 of the embodiment, the wiring component 120 of the present modification includes a first fuse connecting portion 120a to be physically and electrically connected to the first electrical connection portion of the circuit protection component 30 (FIG. 9). In the wiring component 120, the first fuse connecting portion 120a is provided for each busbar 10. The first fuse connecting portion 120a is provided at the conductor exposed portion 121a of the wiring component 120. That is, in the wiring component 120, the first fuse connecting portion 120a is provided in the conductor exposed portion 121a of each line-shaped conductor 121.

In the wiring component 120, similarly to the wiring component 20C of the embodiment, the conductor exposed portion 121a of the line-shaped conductor 121 being a bundle of the plurality of strands may be subjected to forming processing, so as to provide the conductor exposed portion 121a with a terminal portion similar to the terminal portion 21c of the wiring component 20C of the embodiment.

The conductive module 2, similarly to the conductive module 1 of the embodiment, is equipped with an insulating member (not illustrated) that contains the circuit protection component 30, the first fuse connecting portion 120a, and the second fuse connecting portion 41 so as to maintain the connection state of these components. This insulating member is similar to the insulating member 50 of the embodiment. Note that the insulating member of the present modification is adapted to the shape and layout of the circuit protection component 30, the first fuse connecting portion 120a, and the second fuse connecting portion 41 to be contained.

In this manner, the conductive module 2 of the present modification has the wiring component 120, as a replacement of the wiring component 20 provided for each busbar 10 in the conductive module 1 of the embodiment, and thus can achieve the effects similar to those of the conductive module 1 of the embodiment. The conductive module 2 of the present modification has one wiring component 120 in place of the plurality of wiring components 20, making it possible to increase the workability at the time of routing the wiring component 120 as compared with the conductive module 1 of the embodiment.

### Second Modification

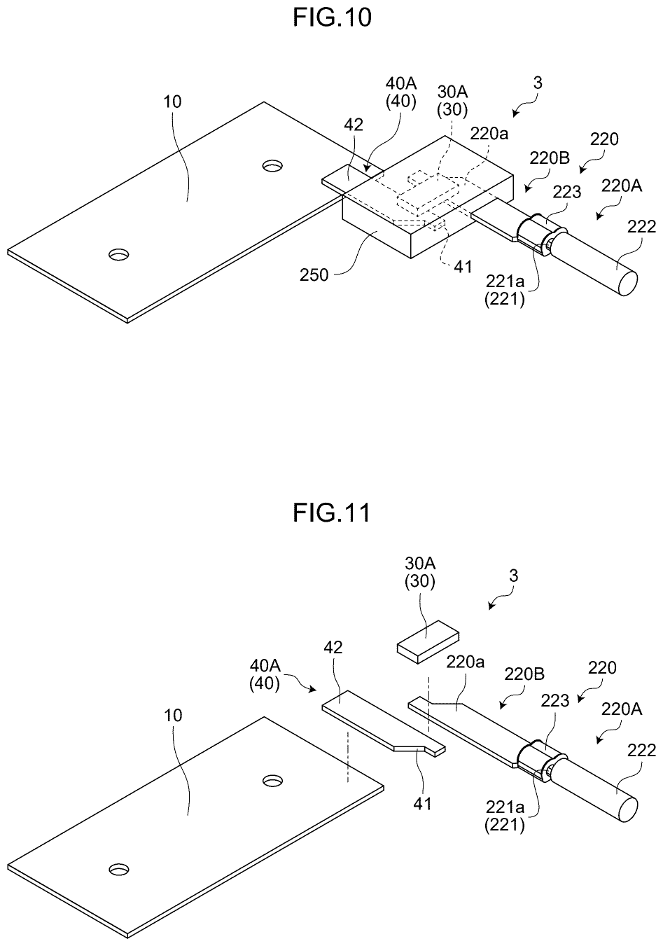

A conductive module 3 of the present modification is obtained by replacing the wiring component 20 in the conductive module 1 of the above-described embodiment with a wiring component 220 described below (FIGS. 10 and 11). Accordingly, in the present modification, the members and portions similar to those of the conductive module 1 of the embodiment are denoted by the same reference numerals as those of the embodiment, and the description thereof will be omitted. In a same manner as the embodiment, the circuit protection component 30 of the present modification may be a chip fuse or a fuse with a wiring pattern. The circuit protection component 30 depicted here is configured as a chip fuse. The busbar-side conductive member 40 of the present modification may be formed as a terminal fitting, or may be an electrical cable, in a same manner as the embodiment. The busbar-side conductive member 40 depicted here is formed as a terminal fitting.

Similarly to the wiring component 20 of the embodiment, the wiring component 220 of the present modification includes a first fuse connecting portion 220a to be physically and electrically connected to the first electrical connection portion of the circuit protection component 30 (FIGS. 10 and 11).

The wiring component 220 of the present modification is an electrical cable (hereinafter, referred to as an “wiring electrical cable”) 220A in which a core wire 221 is covered with an insulating covering 222 (FIGS. 10 and 11). The wiring electrical cable 220A is similar to the wiring electrical cable (wiring component 20) of the embodiment, and has, at its end, a core wire exposed portion 221a of a core wire 221 being exposed in a state of protruding from the insulating covering 222. The wiring component 220 of the present modification includes a terminal fitting (hereinafter, referred to as a “wiring terminal”) 220B physically and electrically connected to the core wire exposed portion 221a (FIGS. 10 and 11). The first fuse connecting portion 220a is provided at the wiring terminal 220B.

The wiring terminal 220B is formed of a conductive material such as metal. The wiring terminal 220B includes an electrical cable connecting portion 223 to be physically and electrically connected to the core wire exposed portion 221a of the wiring electrical cable 220A (FIGS. 10 and 11). The wiring terminal 220B depicted here is formed as a terminal fitting having a flat plate shape extending in one direction, and has its one end in the longitudinal direction defined as the first fuse connecting portion 220a, while having the other end in the longitudinal direction defined as the electrical cable connecting portion 223.

In the conductive module 3, the first fuse connecting portion 220a of the wiring terminal 220B and the first electrical connection portion of the circuit protection component 30 are physically and electrically connected to each other by soldering or welding, for example. For example, the solder may be applied to the first fuse connecting portion 220a in advance, or may be a thread solder to be fed during the connecting operation.

In the conductive module 3, the wiring terminal 220B and the busbar-side conductive member 40 are disposed such that the longitudinal direction of the wiring terminal 220B and the longitudinal direction of the busbar-side conductive member 40 are parallel to each other and such that the first fuse connecting portion 220a of the wiring terminal 220B and the second fuse connecting portion 41 of the busbar-side conductive member 40 face each other. Furthermore, in the conductive module 3, one plane of the first fuse connecting portion 220a of the wiring terminal 220B and one plane of the second fuse connecting portion 41 of the busbar-side conductive member 40 are disposed on an identical plane, so as to dispose the wiring terminal 220B and the busbar-side conductive member 40. Here, the wiring terminal 220B and the busbar-side conductive member 40 are disposed on the identical plane, which is located parallel to the plane of the busbar 10.

In the conductive module 3, when the circuit protection component 30 is a chip fuse (circuit protection component 30A), the circuit protection component 30A is placed on one plane of the first fuse connecting portion 220a of the wiring terminal 220B and one plane of the second fuse connecting portion 41 of the busbar-side conductive member 40, and in this state, the circuit protection component 30A is physically and electrically connected to the first fuse connecting portion 220a and to the second fuse connecting portion 41 by soldering or welding, for example. In the conductive module 3, when the circuit protection component 30 is a fuse with a wiring pattern (circuit protection component 30B), the other plane of the first fuse connecting portion 220a of the wiring terminal 220B and the other plane of the second fuse connecting portion 41 of the busbar-side conductive member 40 are placed on the first electrical connection portion 31a and the second electrical connection portion 31b of the circuit protection component 30B, and the circuit protection component 30B is physically and electrically connected to the first fuse connecting portion 220a and the second fuse connecting portion 41 by soldering or welding, for example.

The electrical cable connecting portion 223 of the wiring terminal 220B depicted here is formed as a crimp terminal portion that crimps a pair of barrel pieces to the core wire exposed portion 221a of the wiring electrical cable 220A. Incidentally, the core wire exposed portion 221a of the wiring electrical cable 220A and the electrical cable connecting portion 223 of the wiring terminal 220B may be physically and electrically connected to each other by soldering or welding, for example.

The conductive module 3, similarly to the conductive module 1 of the embodiment, is equipped with an insulating member 250 (FIG. 10) that contains the circuit protection component 30, the first fuse connecting portion 220a, and the second fuse connecting portion 41 so as to maintain the connection state of these components. This insulating member 250 is similar to the insulating member 50 of the embodiment. Note that the insulating member 250 of the present modification is adapted to the shape and layout of the circuit protection component 30, the first fuse connecting portion 220a, and the second fuse connecting portion 41 to be contained.

In this manner, the conductive module 3 of the present modification has the wiring component 220, as a replacement of the wiring component 20 provided in the conductive module 1 of the embodiment, and thus can achieve the effects similar to those of the conductive module 1 of the embodiment. In addition, the conductive module 3 of the present modification includes the wiring terminal 220B interposed between the core wire exposed portion 221a of the wiring electrical cable 220A and the circuit protection component 30, making it possible to increase the connection stability between the wiring component 220 and the circuit protection component 30.

Here, in the conductive module 3 of the present modification, the wiring electrical cable 220A for each busbar 10 may be replaced with the flat cable (wiring component 120) of the first modification described above. In this case, the wiring component 220 includes the flat cable (wiring component 120) and the wiring terminal 220B for each line-shaped conductor 121 of the flat cable (wiring component 120). The wiring terminal 220B is physically and electrically connected to the end (conductor exposed portion 121a) of the line-shaped conductor 121. In this case, the first fuse connecting portion 220a is provided at the wiring terminal 220B.

### Third Modification

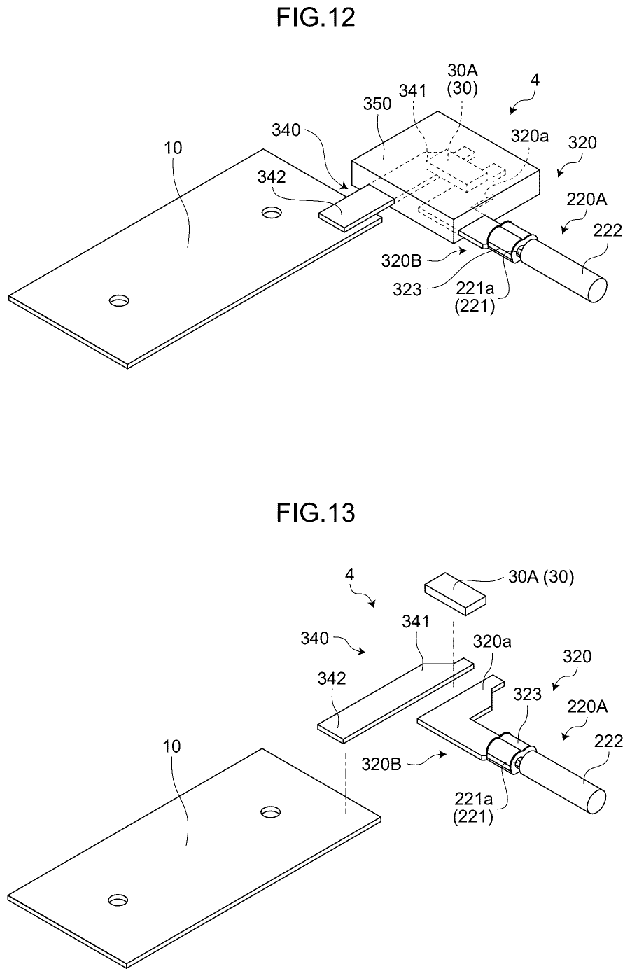

A conductive module 4 of the present modification is obtained by performing replacement in the conductive module 3 of the second modification described above, specifically, by replacing the wiring component 220 with a wiring component 320 described below and replacing the busbar-side conductive member 40 with a busbar-side conductive member 340 described below (FIGS. 12 and 13). Accordingly, in the present modification, the members and portions similar to those of the conductive module 3 of the second modification are denoted by the same reference numerals as those of the second modification, and the description thereof will be omitted. In a same manner as the embodiment, the circuit protection component 30 of the present modification may be a chip fuse or a fuse with a wiring pattern. The circuit protection component 30 depicted here is configured as a chip fuse.

The wiring component 320 of the present modification is obtained by performing replacement in the wiring component 220 of the second modification, specifically by replacing the wiring terminal 220B with a wiring terminal 320B (FIGS. 12 and 13). The wiring terminal 320B of the present modification corresponds to a member obtained by bending the wiring terminal 220B having a straight line shape and a flat plate shape in the second modification, into an L shape along a plane of the terminal. In the wiring terminal 320B, an extending direction of one piece portion forming the L shape is orthogonal to an extending direction of the other piece portion forming the L shape.

In the wiring terminal 320B, a first fuse connecting portion 320a is provided at the one piece portion forming the L shape, while an electrical cable connecting portion 323 is provided at the other piece portion forming the L shape (FIGS. 12 and 13). The first fuse connecting portion 320a is formed similarly to the first fuse connecting portion 220a of the wiring terminal 220B of the second modification, and is physically and electrically connected to the first electrical connection portion of the circuit protection component 30 by soldering or welding, for example. The electrical cable connecting portion 323 is formed similarly to the electrical cable connecting portion 223 of the wiring terminal 220B, and is physically and electrically connected to the core wire exposed portion 221a of the wiring electrical cable 220A. The electrical cable connecting portion 323 depicted here is formed as a crimp terminal portion.

The busbar-side conductive member 340 of the present modification may be formed as a terminal fitting or may be an electrical cable in the same manner as the busbar-side conductive member 40 of the second modification. The busbar-side conductive member 340 depicted here is formed as a terminal fitting. The busbar-side conductive member 340 of the present modification is similar to the busbar-side conductive member 40 of the second modification, but has a length changed in accordance with the arrangement thereof, with respect to the busbar-side conductive member 40. The busbar-side conductive member 340 has its one end in the longitudinal direction formed as a second fuse connecting portion 341 to be physically and electrically connected to the second electrical connection portion of the circuit protection component 30 while having the other end in the longitudinal direction formed as a busbar connecting portion 342 to be physically and electrically connected to the busbar 10 (FIGS. 12 and 13).

The second fuse connecting portion 341 is physically and electrically connected to the second electrical connection portion of the circuit protection component 30 by soldering or welding, for example.

The busbar-side conductive member 340 of the present modification physically and electrically connects the busbar connecting portion 342 to the busbar 10 in a state where the second fuse connecting portion 341 protrudes from the busbar 10 in a direction toward the line-up direction of the plurality of battery cells BC. Similarly to the busbar connecting portion 42 of the busbar-side conductive member 40 of the second modification, the busbar connecting portion 342 may be physically and electrically connected to the busbar 10 by welding, for example, may be physically and electrically connected to the busbar 10 by screwing fixing, or may be fitted and connected to the busbar 10 with a mating connection.

In the conductive module 4, the wiring terminal 320B and the busbar-side conductive member 340 are disposed such that the longitudinal direction of one piece portion of the wiring terminal 320B equipped with the first fuse connecting portion 320a and the longitudinal direction of the busbar-side conductive member 340 are parallel to each other and such that the first fuse connecting portion 320a and the second fuse connecting portion 341 of the busbar-side conductive member 340 face each other. Furthermore, in the conductive module 4, one plane of the first fuse connecting portion 320a of the wiring terminal 320B and one plane of the second fuse connecting portion 341 of the busbar-side conductive member 340 are disposed on an identical plane, so as to dispose the wiring terminal 320B and the busbar-side conductive member 340. Here, the wiring terminal 320B and the busbar-side conductive member 340 are disposed on the identical plane, which is located parallel to the plane of the busbar 10.

In the conductive module 4, depending on whether the circuit protection component 30 is a chip fuse or a fuse with a wiring pattern, the circuit protection component 30 is physically and electrically connected to the first fuse connecting portion 320a of the wiring terminal 320B and to the second fuse connecting portion 341 of the busbar-side conductive member 340 by soldering or welding, for example, in the same manner as the conductive module 3 of the second modification.

The conductive module 4, similarly to the conductive module 3 of the second modification, is equipped with an insulating member 350 (FIG. 12) that contains the circuit protection component 30, the first fuse connecting portion 320a, and the second fuse connecting portion 341 so as to maintain the connection state of these components. The insulating member 350 is similar to the insulating member 250 of the second modification. Note that the insulating member 350 of the present modification is adapted to the shape and layout of the circuit protection component 30, the first fuse connecting portion 320a, and the second fuse connecting portion 341 to be contained.

In this manner, the conductive module 4 of the present modification has the wiring component 320, as a replacement of the wiring component 220 provided in the conductive module 3 of the second modification, and thus can achieve the effects similar to those of the conductive module 3 of the second modification.

Here, in the conductive module 4 of the present modification, the wiring electrical cable 220A for each busbar 10 may be replaced with the flat cable (wiring component 120) of the first modification described above. In this case, the wiring component 320 includes the flat cable (wiring component 120) and the wiring terminal 320B for each line-shaped conductor 121 of the flat cable (wiring component 120). The wiring terminal 320B is physically and electrically connected to the end (conductor exposed portion 121a) of the line-shaped conductor 121. In this case, the first fuse connecting portion 320a is provided at the wiring terminal 320B.

In the conductive module 4 of the present modification, the busbar-side conductive member 340 may be an electrical cable (not illustrated).

### Fourth Modification

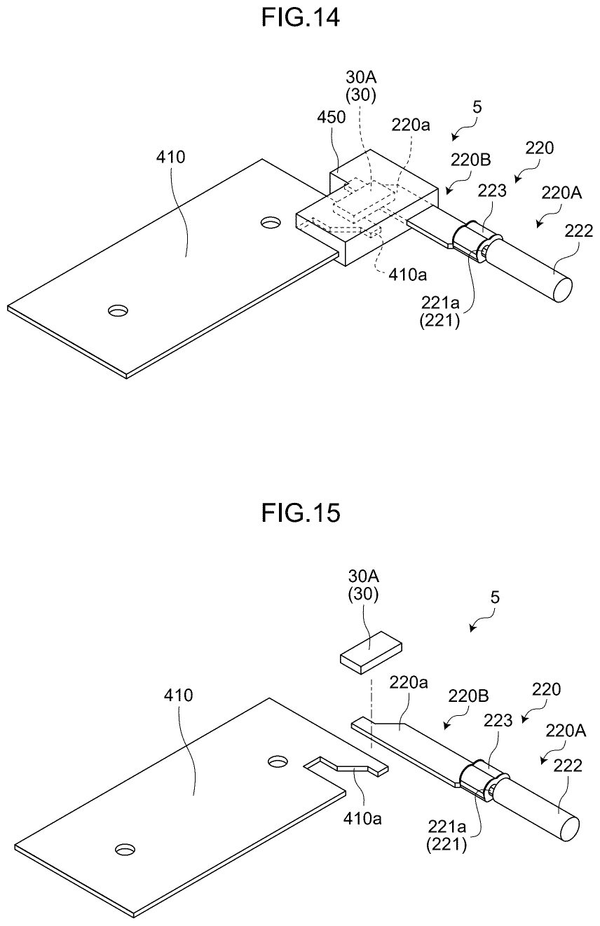

A conductive module 5 of the present modification is obtained by performing replacement and removal (FIGS. 14 and 15) in the conductive module 1 of the embodiment or the conductive module 3 of the second modification, specifically by removing the busbar-side conductive member 40 and replacing the busbar 10 with a busbar 410 described below. Here is an example in which replacement and removal are performed in the conductive module 3 of the second modification, specifically, the busbar-side conductive member 40 is removed, and the busbar 10 is replaced with the busbar 410 described below. Accordingly, in the present modification, the members and portions similar to those of the conductive module 3 of the second modification are denoted by the same reference numerals as those of the embodiment, and the description thereof will be omitted. In a same manner as the second modification, the circuit protection component 30 of the present modification may be a chip fuse or a fuse with a wiring pattern. The circuit protection component 30 depicted here is configured as a chip fuse.

In the conductive module 5 of the present modification, the busbar 410 has a second fuse connecting portion 410a, and the second fuse connecting portion 410a and the second electrical connection portion of the circuit protection component 30 are physically and electrically connected by soldering or welding, for example (FIGS. 14 and 15). The busbar 410 of the present modification is formed in a rectangular flat plate shape similarly to the busbar 10 of the second modification, but partially has a notch to form the second fuse connecting portion 410a. The second fuse connecting portion 410a depicted here is formed as a piece portion extending in a direction orthogonal to the line-up direction of the plurality of battery cells BC at a corner of the busbar 410.

The conductive module 5, similarly to the conductive module 3 of the second modification, is equipped with an insulating member 450 (FIGS. 14 and 15) that contains the circuit protection component 30, the first fuse connecting portion 220a, and the second fuse connecting portion 410a so as to maintain the connection state of these components. The insulating member 450 is similar to the insulating member 250 of the second modification. Note that the insulating member 450 of the present modification is adapted to the shape and layout of the circuit protection component 30, the first fuse connecting portion 220a, and the second fuse connecting portion 410a to be contained.

In the conductive module 5 of the present modification, the busbar 10 in the conductive module 1 of the embodiment or the conductive module 3 of the second modification is replaced with the busbar 410 so as to equip the busbar 410 with functions of the busbar-side conductive member 40. Therefore, the conductive module 5 of the present modification can achieve the effect similar to the conductive module 1 of the embodiment or the conductive module 3 of the second modification. The conductive module 5 of the present modification corresponds to the configuration of the conductive module 1 of the embodiment or the conductive module 3 of the second modification without the busbar-side conductive member 40, making it possible to reduce the size and cost as compared with the conductive module 1 of the embodiment or the conductive module 3 of the second modification.

Here, in the conductive module 5 of the present modification, the wiring component 20 (wiring electrical cable) for each busbar 410 may be replaced with the flat cable (wiring component 120) of the first modification described above.

### Fifth Modification

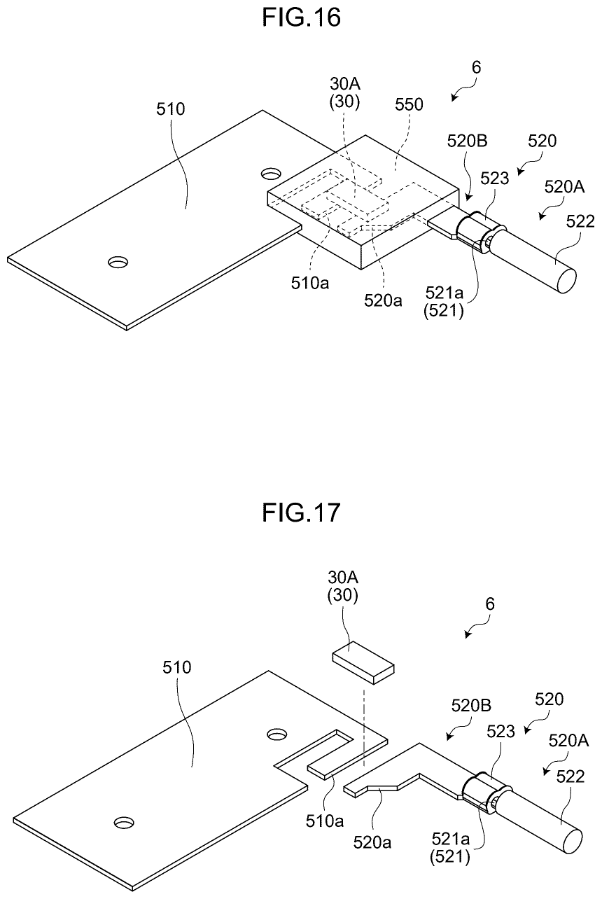

A conductive module 6 of the present modification is obtained by performing replacement in the conductive module 5 of the fourth modification, specifically by replacing the busbar 410 with a busbar 510 described below and replacing the wiring component 220 with a wiring component 520 described below (FIGS. 16 and 17). Accordingly, in the present modification, the members and portions similar to those of the conductive module 5 of the fourth modification are denoted by the same reference numerals as those of the fourth modification, and the description thereof will be omitted. In a same manner as the embodiment, the circuit protection component 30 of the present modification may be a chip fuse or a fuse with a wiring pattern. The circuit protection component 30 depicted here is configured as a chip fuse.

Similarly to the busbar 410 of the fourth modification, the busbar 510 of the present modification has a notch in a part of a main body having a rectangular flat plate shape so as to form a second fuse connecting portion 510a (FIGS. 16 and 17). The second fuse connecting portion 510a depicted here is formed as a piece portion extending in the line-up direction of the plurality of battery cells BC at a corner of the busbar 510.

Similarly to the wiring component 220 of the fourth modification, the wiring component 520 of the present modification includes a first fuse connecting portion 520a to be physically and electrically connected to the first electrical connection portion of the circuit protection component 30 (FIGS. 16 and 17).

The wiring component 520 of the present modification includes an electrical cable (hereinafter, referred to as a “wiring electrical cable”) 520A in which a core wire 521 is covered with an insulating covering 522 (FIGS. 16 and 17). The wiring electrical cable 520A is similar to the wiring electrical cable 220A of the fourth modification, and has, at its end, a core wire exposed portion 521a of the core wire 521 being exposed in a state of protruding from the insulating covering 522. The wiring component 520 of the present modification includes a terminal fitting (hereinafter, referred to as a “wiring terminal”) 520B physically and electrically connected to the core wire exposed portion 521a. The first fuse connecting portion 520a is provided at the wiring terminal 520B.

The wiring terminal 520B of the present modification is bent in an L shape in the same manner as the wiring terminal 320B of the third modification. In the wiring terminal 520B, a first fuse connecting portion 520a is provided at the one piece portion forming the L shape, while an electrical cable connecting portion 523 is provided at the other piece portion forming the L shape (FIGS. 16 and 17). The first fuse connecting portion 520a is physically and electrically connected to the first electrical connection portion of the circuit protection component 30 by soldering or welding, for example. The electrical cable connecting portion 523 is physically and electrically connected to the core wire exposed portion 521a of the wiring electrical cable 520A. The electrical cable connecting portion 523 depicted here is formed as a crimp terminal portion.

In the conductive module 6, the wiring terminal 520B and the busbar 510 are disposed such that the longitudinal direction of one piece portion of the wiring terminal 520B equipped with the first fuse connecting portion 520a and the longitudinal direction of the second fuse connecting portion 510a in the busbar 510 are parallel to each other and such that the first fuse connecting portion 520a and the second fuse connecting portion 510a face each other. Furthermore, in the conductive module 6, one plane of the first fuse connecting portion 520a of the wiring terminal 520B and one plane of the second fuse connecting portion 510a of the busbar 510 (that is, one plane of the busbar 510) are disposed on an identical plane, so as to dispose the wiring terminal 520B and the busbar 510.

The conductive module 6, similarly to the conductive module 5 of the fourth modification, is equipped with an insulating member 550 (FIGS. 16 and 17) that contains the circuit protection component 30, the first fuse connecting portion 520a, and the second fuse connecting portion 510a so as to maintain the connection state of these components. The insulating member 550 is similar to the insulating member 450 of the fourth modification. Note that the insulating member 550 of the present modification is adapted to the shape and layout of the circuit protection component 30, the first fuse connecting portion 520a, and the second fuse connecting portion 510a to be contained.

In this manner, the conductive module 6 of the present modification has the busbar 510 and the wiring component 520, respectively as replacements of the busbar 410 and the wiring component 220 provided in the conductive module 5 of the fourth modification, and thus can achieve the effects similar to those of the conductive module 5 of the fourth modification.

Here, in the conductive module 6 of the present modification, the wiring electrical cable 520A for each busbar 510 may be replaced with the flat cable (wiring component 120) of the first modification described above. In this case, the wiring component 520 includes the flat cable (wiring component 120) and the wiring terminal 520B for each line-shaped conductor 121 of the flat cable (wiring component 120). The wiring terminal 520B is physically and electrically connected to the end (conductor exposed portion 121a) of the line-shaped conductor 121. In this case, the first fuse connecting portion 520a is provided at the wiring terminal 520B.

The conductive module according to the present embodiment includes a circuit protection component such as a chip fuse or a fuse with a wiring pattern, smaller in size than a mechanical fuse such as a blade fuse, and allows the circuit protection component to be directly connected to the first fuse connecting portion of the wiring component and to the second fuse connecting portion on the busbar side. This makes the conductive module according to the present invention a downsized module with excellent mountability.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A conductive module comprising:
a busbar physically and electrically connected to an electrode terminal of a battery cell constituting a battery module;
a wiring component configured to electrically connect the busbar to a battery monitoring unit that monitors a battery state of the battery cell;
a conductive member physically and electrically connected to the busbar; and
a circuit protection component configured either as a chip fuse having a fusible portion to be fused when an overcurrent flows or a fuse with a wiring pattern in which a wiring pattern having the fusible portion is provided on a printed circuit board, the circuit protection component being configured to physically and electrically connect a first electrical connection portion on one end side as viewed from the fusible portion, to a first fuse connecting portion of the wiring component, and physically and electrically connect a second electrical connection portion on the other end side as viewed from the fusible portion, to a second fuse connecting portion of the conductive member.

2. The conductive module according to claim 1, wherein
the conductive member is either a terminal fitting or an electrical cable.

3. A conductive module comprising:
a busbar physically and electrically connected to an electrode terminal of a battery cell constituting a battery module;
a wiring component configured to electrically connect the busbar to a battery monitoring unit that monitors a battery state of the battery cell; and
a circuit protection component configured either as a chip fuse having a fusible portion to be fused when an overcurrent flows or a fuse with a wiring pattern in which a wiring pattern having the fusible portion is provided on a printed circuit board, the circuit protection component being configured to physically and electrically connect a first electrical connection portion on one end side as viewed from the fusible portion, to a first fuse connecting portion of the wiring component, and physically and electrically connect a second electrical connection portion on the other end side as viewed from the fusible portion, to a second fuse connecting portion of the busbar.

4. The conductive module according to claim 1, wherein
the wiring component is a wiring electrical cable having a core wire covered with an insulating covering, and
the first fuse connecting portion is provided at a core wire exposed portion of the core wire, the core wire exposed portion being exposed from the insulating covering at an end of the wiring component.

5. The conductive module according to claim 2, wherein
the wiring component is a wiring electrical cable having a core wire covered with an insulating covering, and
the first fuse connecting portion is provided at a core wire exposed portion of the core wire, the core wire exposed portion being exposed from the insulating covering at an end of the wiring component.

6. The conductive module according to claim 3, wherein
the wiring component is a wiring electrical cable having a core wire covered with an insulating covering, and
the first fuse connecting portion is provided at a core wire exposed portion of the core wire, the core wire exposed portion being exposed from the insulating covering at an end of the wiring component.

7. The conductive module according to claim 4, wherein
the core wire is formed as a bundle of a plurality of strands, and
the core wire exposed portion includes a terminal portion having the plurality of strands welded together, and a planar portion of the terminal portion is used as the first fuse connecting portion.

8. The conductive module according to claim 1, wherein
the wiring component is a flat cable in which a line-shaped conductor for each of the busbars is covered with an insulating covering, and
the first fuse connecting portion is provided at an end of the line-shaped conductor exposed from the insulating covering.

9. The conductive module according to claim 2, wherein
the wiring component is a flat cable in which a line-shaped conductor for each of the busbars is covered with an insulating covering, and
the first fuse connecting portion is provided at an end of the line-shaped conductor exposed from the insulating covering.

10. The conductive module according to claim 3, wherein
the wiring component is a flat cable in which a line-shaped conductor for each of the busbars is covered with an insulating covering, and
the first fuse connecting portion is provided at an end of the line-shaped conductor exposed from the insulating covering.

11. The conductive module according to claim 1, wherein
the wiring component includes a wiring electrical cable having a core wire covered with an insulating covering, and a wiring terminal physically and electrically connected to a core wire exposed portion of the core wire, the core wire exposed portion being exposed from the insulating covering at an end of the wiring electrical cable, and
the first fuse connecting portion is provided at the wiring terminal.

12. The conductive module according to claim 2, wherein
the wiring component includes a wiring electrical cable having a core wire covered with an insulating covering, and a wiring terminal physically and electrically connected to a core wire exposed portion of the core wire, the core wire exposed portion being exposed from the insulating covering at an end of the wiring electrical cable, and
the first fuse connecting portion is provided at the wiring terminal.

13. The conductive module according to claim 3, wherein
the wiring component includes a wiring electrical cable having a core wire covered with an insulating covering, and a wiring terminal physically and electrically connected to a core wire exposed portion of the core wire, the core wire exposed portion being exposed from the insulating covering at an end of the wiring electrical cable, and
the first fuse connecting portion is provided at the wiring terminal.

14. The conductive module according to claim 1, wherein
the wiring component includes a flat cable in which a line-shaped conductor for each of the busbars is covered with an insulating covering, and a wiring terminal for each of the line-shaped conductors, the wiring terminal being physically and electrically connected to an end of the line-shaped conductor exposed from the insulating covering, and
the first fuse connecting portion is provided at the wiring terminal.

15. The conductive module according to claim 2, wherein
the wiring component includes a flat cable in which a line-shaped conductor for each of the busbars is covered with an insulating covering, and a wiring terminal for each of the line-shaped conductors, the wiring terminal being physically and electrically connected to an end of the line-shaped conductor exposed from the insulating covering, and
the first fuse connecting portion is provided at the wiring terminal.

16. The conductive module according to claim 3, wherein
the wiring component includes a flat cable in which a line-shaped conductor for each of the busbars is covered with an insulating covering, and a wiring terminal for each of the line-shaped conductors, the wiring terminal being physically and electrically connected to an end of the line-shaped conductor exposed from the insulating covering, and
the first fuse connecting portion is provided at the wiring terminal.

17. The conductive module according to claim 1, further comprising:
an insulating member that contains the circuit protection component, the first fuse connecting portion, and the second fuse connecting portion.

18. The conductive module according to claim 2, further comprising:
an insulating member that contains the circuit protection component, the first fuse connecting portion, and the second fuse connecting portion.

19. The conductive module according to claim 3, further comprising:
an insulating member that contains the circuit protection component, the first fuse connecting portion, and the second fuse connecting portion.

20. The conductive module according to claim 17, wherein
the insulating member is either a molded body insert-molded by containing the circuit protection component, the first fuse connecting portion, and the second fuse connecting portion; or a cured body obtained by curing a potting liquid containing the circuit protection component, the first fuse connecting portion, and the second fuse connecting portion.
